(19) United States
(12) Patent Application Publication
(10) Pub. No.: US 2013/0319930 A1
(43) Pub. Date: Dec. 5, 2013

(54) INTERFERENCE FIT FOR HIGH PRESSURE FUEL SYSTEM COMPONENT

(71) Applicants: Tamas Rauznitz, Columbus, IN (US); Deepak Sahini, Columbus, IN (US); Jeffrey J. Sullivan, Columbus, IN (US)

(72) Inventors: Tamas Rauznitz, Columbus, IN (US); Deepak Sahini, Columbus, IN (US); Jeffrey J. Sullivan, Columbus, IN (US)

(73) Assignee: CUMMINS INTELLECTUAL PROPERTY, INC., Minneapolis, MN (US)

(21) Appl. No.: 13/484,235

(22) Filed: May 30, 2012

(51) Int. Cl. B01D 29/44

(52) U.S. Cl. 210/446

(57) ABSTRACT

This disclosure provides an edge filter assembly for delivering high pressure or pressurized fuel to a cylinder an internal combustion engine and a high pressure connector and edge filter assembly that provides a pressurized fluid connection between a high pressure fuel line and an inlet of a fuel injector. The edge filter assembly and high pressure connector and edge filter assembly each have a geometric feature that can provide increased retention force to an interference fit of the edge filter with the assembly.

### TECHNICAL FIELD

The disclosure relates to an interference fit for a fuel line component in an internal combustion engine system, and more particularly, to a bore having an interference fit for an edge filter of the high pressure fuel line assembly.

### BACKGROUND

Today's high pressure fuel systems utilize edge filters in high pressure fluid paths between a high pressure pump and fuel injector nozzles. Typically, an edge filter is positioned in a bore of a high pressure connector (HPC) tube or in a bore in the body of the fuel injector upstream of the injector's nozzle discharge orifice via a hydraulic press, and a portion of the filter forms an interference fit with the surface of the bore.

Edge filters are generally cylindrical shaped and include upstream grooves (flutes) adjacent to downstream grooves formed on its outer surface in the direction of the longitudinal axis of the filter. The upstream grooves alternate with the downstream grooves in a circumferential direction around the longitudinal axis. The upstream grooves open at a first of two opposing ends of the filter facing incoming fuel flow and close before reaching a second of the two opposing ends. Similarly, the downstream grooves open at the second opposing end and close before reaching the first opposing end. A rib is present between each pair of adjacent grooves and forms a longitudinally directed edge.

With the edge filter installed in the bore of the HPC tube or a fuel injector, a clearance space between the ribs along the downstream portion of the filter and the bore surface allows fluid to flow across the ribs in the bore. The amount of spacing between the bore surface and the rib is controlled and determined according to a desired, acceptable maximum size of particulate matter or debris in the fuel allowed to pass through the orifice of the fuel injector nozzle. The edge filer and bore thus allow fuel to pass from the upstream flutes to the downstream flutes in a clearance zone while trapping particles and debris in the fuel flow.

### SUMMARY

This disclosure provides an edge filter assembly and a high pressure connector and edge filter assembly for retaining an edge filter, each of which can provide a pressurized fluid connection between fuel system components. The edge filter assembly and high pressure connector and edge filter assembly each have a geometric feature that can provide increased retention force to an interference fit of an edge filter when the assembly is dilated under high pressure.

In one disclosed embodiment, an edge filter assembly for supplying filtered fuel to a cylinder of an internal combustion engine includes a body having a passage for flowing pressurized fuel. The passage includes a longitudinal axis, a fuel inlet, a fuel outlet positioned downstream of the fuel inlet in a direction of fuel flow, and a bore including a first annular surface and a second annular surface adjacent to, and downstream of the first annular surface in the direction of fuel flow. An edge filter is positioned in the bore and includes a first surface in interference fit with the first annular surface, and a second surface circumferentially surrounded by, and spaced from, the second annular surface. The interference fit has a length along the direction of fuel flow and the first annular surface has a positive taper along the length.

In another disclosed embodiment, a high pressure connector and edge filter assembly for providing a pressurized fluid connection between a high pressure fuel line and an inlet of a fuel injector includes a fuel inlet end and a fuel outlet end configured to mechanically and sealingly engage with the high pressure fuel line and the fuel inlet of a fuel injector, respectively. An inner passage extends between the fuel inlet end and the fuel outlet end contains an edge filter and includes a conically shaped surface forming an interference fit with a first surface portion of the edge filter. A cylindrically shaped surface region extends from the conical surface towards the fuel outlet end of the inner passage and is radially spaced from a second surface portion of the edge filter.

### BRIEF DESCRIPTION OF THE DRAWINGS

FIG. 1 is a graph showing retention force needed at 3000 bar to move an edge filter for different amounts of interference in a zone of interference (ZI) region.

FIG. 2 is a diagram showing a cross section of a high pressure edge filter assembly according to an exemplary embodiment.

FIG. 3A is a diagram showing a cross section of portions of fuel system components of the edge filter assembly shown in FIG. 2 prior to assembling the components, where the bore includes a positive taper in a ZI region.

FIG. 3B is a diagram showing available elastic recovery potential of an edge filter installed in a bore to form a ZI region, where the ZI region includes a positive taper and is at a low pressure or in an unpressurized state.

FIG. 3C is a diagram showing available elastic recovery potential of the edge filter shown in FIG. 3B at high pressure.

FIG. 4 is a graph showing retention force needed at 3000 bar to move an edge filter for different angles of bore taper in a ZI region.

FIG. 5 is a diagram of an exemplary bore profile for retaining an edge filter, where a positive taper in the ZI region is curved and a rate of the taper angle changes smoothly along the length of the ZI region.

FIG. 6 is a diagram of an exemplary bore profile for retaining an edge filter, where a taper angle in the ZI region changes in piecewise manner.

FIG. 7A is a diagram showing a cross section of portions of fuel system components of an edge filter assembly assembling the components, where a bore includes a negative taper in a ZI region.

FIG. 7B is a diagram showing available elastic recovery potential of an edge filter installed in a bore to form a ZI region, where the ZI region includes a negative taper and is at a low pressure or in an unpressurized state.

FIG. 7C is a diagram showing available elastic recovery potential of the edge filter shown in FIG. 7B at high pressure.

### DETAILED DESCRIPTION

The inventors realized that while an interference fit of an edge filter in a fuel passage bore performed satisfactorily with fuel system pressures in the 1200-1800 bar range, edge filters have a tendency to come loose at higher pressures. For instance, the pressure in today's fuel systems can run as high as 2600 bar, which causes greater dilation of fuel system components including a bore retaining an edge filter. As a result, edge filters can become loose within the bore and cause fretting between the filter and bore to generate debris instead of filtering it.

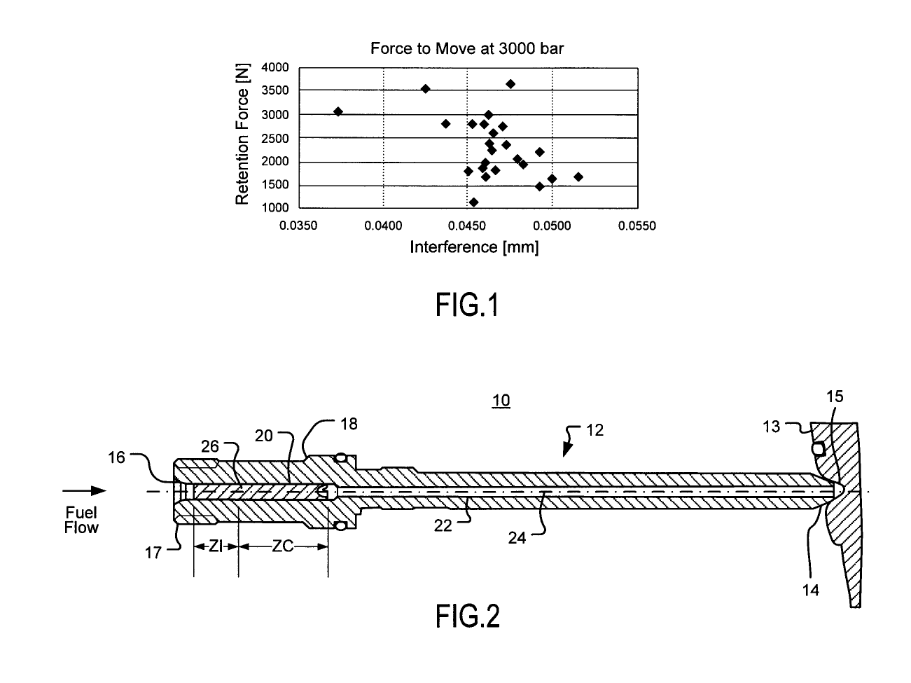

The inventors also realized that there is low to no significant correlation of increased retention load with increasing the interference between the edge filter and bore, applying a surface finish to the bore and/or the edge filter, increasing edge filter hardness, heat treating the edge filter and bore material, and adding geometric tolerance to the edge filter. For instance, FIG. 1 shows that a retention force needed at 3000 bar to move an edge filter for different amounts of interference in a bore zone of interference demonstrates little to no correlation between retention load and the amount of interference between the parts.

However, the inventors discovered that providing a geometric feature to the interference zone of the bore has strong correlation with retention load and can prevent the edge filter from becoming loose within the bore at high fuel pressure.

This disclosure provides a high pressure (pressurized) fuel system component including a bore that is configured to receive an edge filter in the direction of fuel flow and retain the filter such that it will not move with an applied force of less than a prescribed value. The bore includes a zone of interference (ZI) region in which an interference fit is made between a first region of the bore surface and a first portion of the edge filter, and a zone of clearance (ZC) region in which a second region of the bore surface and a second portion of the edge filter define a filtering structure. The ZI region of the bore includes a geometric feature that allows for elastic recovery of the edge filter surface during high pressure operation to maintain frictional contact between the edge filter and bore surface in an amount sufficient to prevent movement of the edge filter within the bore. In the following exemplary embodiments, a high pressure connector (HPC) tube is described as a component including a bore with a geometric feature. It is to be understood, however, that other pressurized fuel system components present between the high pressure pump and the fuel injector nozzle can include such a bore. For example, the body of a fuel injector can include a bore having a geometric feature, as described herein, in a section of the injector upstream in the fuel flow from the fuel exit orifice. Thus, it is to be understood that the concepts described herein can be applied to any press-fit type edge filter assembly configured to operate under high pressure.

Referring now to the drawings, FIG. 2 shows an exemplary embodiment of an edge filter assembly 10 in cross-sectional view. Edge filter assembly 10 is part of a high pressure fuel circuit of an internal combustion engine including cylinders formed in an engine block (not shown). Each of the cylinders contains a reciprocating piston and all the cylinders are covered with a cylinder head including intake and exhaust valves to define plural combustion chambers. The high pressure fuel circuit includes a pressurized fuel passage connected between a high pressure (HP) fuel pump (not shown) and a high pressure common rail (accumulator) (not shown). Plural high pressure fuel lines fluidly connect the accumulator and respective high pressure connector (HPC) tubes 12. Each HPC tube 12, in turn, fluidly connects one of the high pressure fuel lines to a fuel injector 13 associated with one of the combustion chambers. Only a portion of the fuel injector 13 is shown in FIG. 2. The HPC tube 12 includes an outlet having a conical surface 14 that is held in pressure sealing engagement with a complementary shaped surface of fuel inlet 15 of the fuel injector 13. The end of the HPC tube 12 receiving fuel flow includes a conical surface 16 that is held in pressure sealing engagement with a high pressure fuel line (not shown) via a connecting fuel line connector (not shown) to threads 17. While not shown, each HPC tube 12 and fuel injector 13 pair are positioned in respective bores formed in the cylinder head, where the bores intersect in the area of the inlet 15 of the fuel injector 13. In an embodiment, an outer portion of each HPC bore in the cylinder head includes a threaded portion for receiving a clamp nut (not shown) that retains the HPC tube 12 within the bore and provides the pressure sealing engagement between conical surface 14 and fuel inlet 15 by way of the clamp nut end engaging seating surfaces 18.

As shown in FIG. 2, a passage having a longitudinal axis 24 extends along the length of the HPC tube 12 and includes a bore 20 fluidly connected to a fuel channel 22 along of the HPC tube 12. An edge filter 26 is inserted, for example, by way of a hydraulic press, into the bore 20 at the fuel flow receiving end of the HPC tube 12. The bore 20 includes the ZI region and the ZC region, each of which corresponds to a portion of the edge filter 26 after installation. Exemplary dimensions for the ZC and ZI regions are shown in the following table.

TABLE

| | MIN | NOM | MAX |
|---|---|---|---|
| | Zone of Clearance (ZC) | | |
| HPC OD [mm] | 4.980 | 5.000 | 5.020 |
| Edge Filter OD [mm] | 4.920 | 4.930 | 4.940 |
| Clearance [mm] | 0.040 | 0.070 | 0.100 |
| | Zone of Interference (ZI) | | |
| HPC OD [mm] | 4.980 | 5.000 | 5.020 |
| Edge Filter OD [mm] | 5.044 | 5.055 | 5.066 |
| Interference [mm] | 0.024 | 0.055 | 0.086 |

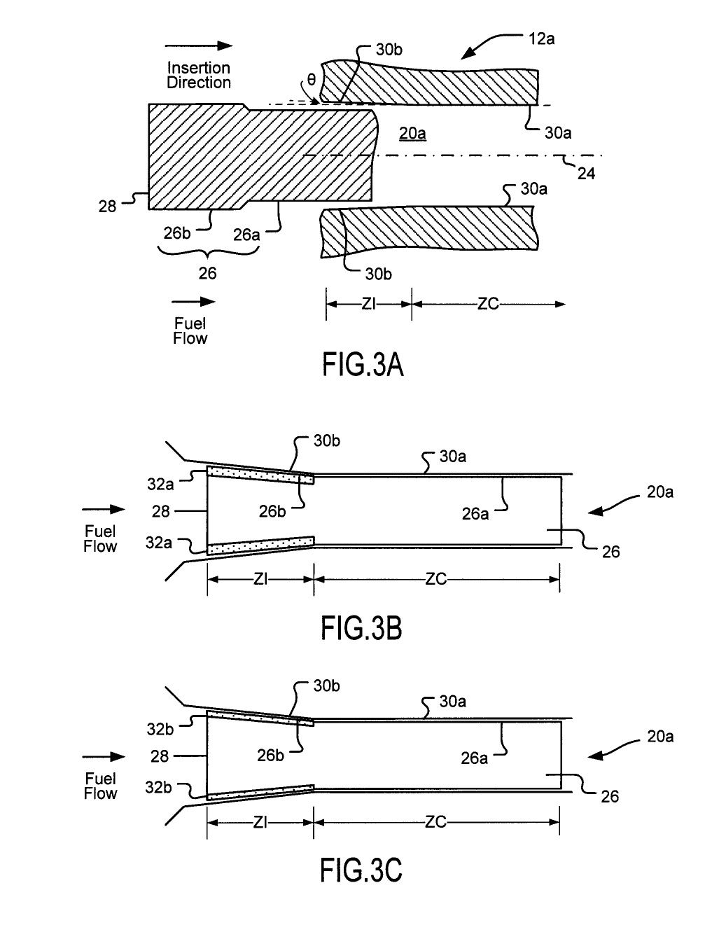

An exemplary geometric feature that provides for increased retention force under high pressure will now be described with reference to FIGS. 3A to 3C. It is to be understood that any figure hereafter including an element having a same reference number as one described in connection with a previous figure indicates a same or similar element as the described element, and that repetition of that description may not be provided for brevity. FIG. 3A is a diagram of portions of a bore 20a and an edge filter 26 in the uninstalled state. The ZI and ZC regions shown in FIG. 3A respectively indicate regions in the bore 20a where the interference fit and clearance/filtering regions of the edge filter 26 occur after installation of the filter in the bore 20a. The bore 20a includes an annular surface 30a where the ZC region is formed and an annular surface 30b upstream from the ZC region (i.e., upstream relative to the fuel flow direction) where the ZI region is formed. In the direction of the fuel flow, annular surface 30b decreases in diameter to define a positive taper angle θ between the annular surface 30b in the ZI region and a line parallel with the longitudinal axis 24. In other words, the radial distance between the longitudinal axis 24 and the annular surface 30b decreases along the length of the ZI region in the direction of edge filter insertion (or fuel flow). In an exemplary embodiment, the positive tapered annular surface 30b in the ZI region has a frusto-conical shape with a diameter, as measured in a direction perpendicular to the longitudinal axis 24, decreasing along the length of the ZI region in the insertion (or fuel flow) direction, and the annular surface 30a is cylindrically shaped. In an exemplary embodiment, a diameter of the annular surface 30b decreases in the ZI region by at least 0.001 mm. Additionally, the tapered annular surface 30b can have a diameter that decreases in the direction of fuel flow to a minimum diameter, where the minimum diameter is substantially the same diameter the cylindrically shaped annular surface 30a forming the ZC region with the edge filter 26. It is to be understood that taper angles θ shown in any figure herein are exaggerated for purposes of explaining concepts of the present disclosure.

When installing edge filter 26 in the bore 20a, the edge filter 26 is pressed from side 28 to move a leading edge of edge filter surface 26b toward the tapered annular surface 30b. The edge filter surface 26b eventually contacts the tapered surface and slides across the annular surface 30b. During this process, the edge filter surface 26b yields in elastic and plastic deformation to create an interference fit across the length of the ZI region. That is, the length of the ZI region as measured along the longitudinal axis 24 is the length of the interference fit formed between the edge filter surface 26b and the tapered bore surface 30b. In an embodiment, the length of the interference fit is preferably 30% of the length of the edge filter 26, although the ZI region can be about 10% to 30% of the entire longitudinal length of the edge filter 26 to achieve appreciable increase in edge filter retention load.

The shape of the bore 20a in the ZC region upstream from the ZI region does not need control outside of size tolerance dimensions, such as those in the above Table. In the ZC region, edge filter surface 26a is surrounded by the annular surface 30a, but does not contact the annular surface 30a so as to provide the edge filtering function, although an alternative embodiment of an edge filter can include a spacer portion that makes contact with the annular surface 30a for a limited longitudinal extent along the longitudinal axis 24.

FIG. 3B conceptually illustrates an elastic recovery potential 32a remaining in the edge filter portion 26b, with the edge filter 26 installed in bore 20a having positive taper at surface 30b and in a low pressure or unpressurized state. Elastic recovery is the amount of available spring-back stored in the edge filter in the ZI region after compression by HPC tube 12a. Due to the hardness difference between the HPC 12a and the edge filter, i.e., the material of HPC 12a has a greater measure of hardness compared with the material of edge filter 26, the shape of the HPC tube 12a dominates and the edge filter surface 26b complies with the shape of the HPC 12a, i.e., essentially all the yielding takes place in the edge filter 26 in the ZI region. When edge filter 26 and HPC tube 12a are assembled with an interference fit, both edge filter 26 and HPC tube 12a deform elastically. While the HPC tube 12a remains in the elastic region, the portion of edge filter 26 in the ZI region crosses into the plastic region because its material yield limit is lower than that of the HPC tube material. The elastic recovery potential 32a that remains in edge filter 26 extends across the entire ZI region between edge filter surface 26b and annular surface 30b.

FIG. 3C conceptually illustrates the elastic recovery potential 32b remaining in the installed edge filter 26 with the bore 20a subject to high pressure or in a pressurized state. With positive taper, although elastic recovery potential 32a is reduced as a result of dilation of the bore 20a, elastic recovery potential 32a continues to extend across substantially the entire annular surface 30b in the ZI region. Hence, the full amount of elasticity recovery due to the interference fit of the edge filter 26 is available to follow dilation of HPC 12a.

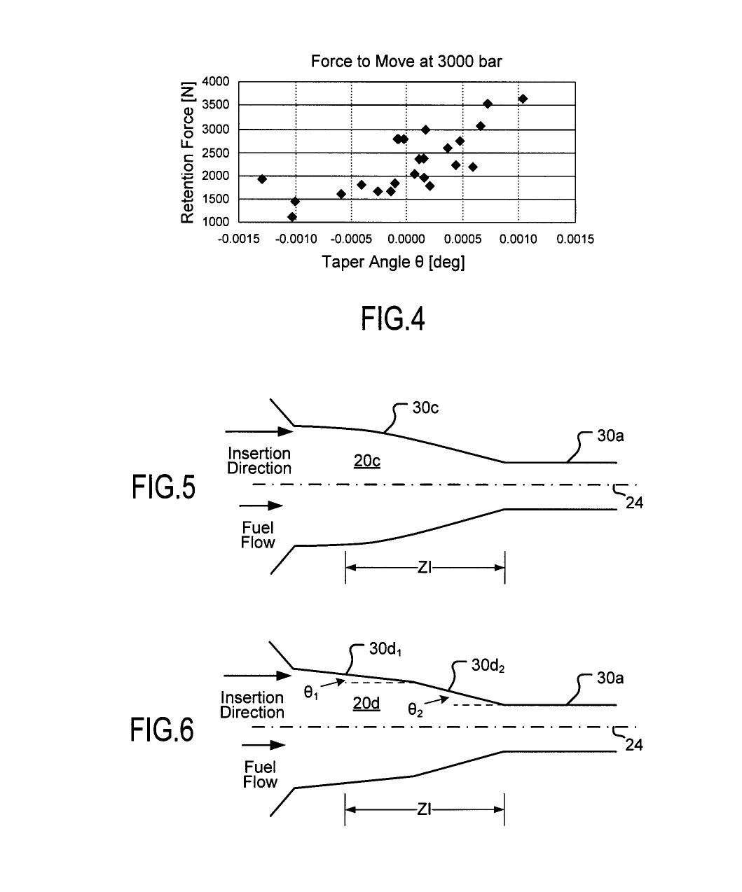

FIG. 4 is a graph of test data showing retention force needed at 3000 bar to move an edge filter for different angles of bore taper in a bore zone of interference. As can be seen from FIG. 4, there is very strong correlation between taper direction and retention load with a bore having a positive taper. The positive taper gives higher retention force for the edge filter because there is more elasticity due to interference remaining in the edge filter. FIG. 4 also shows that in a pressurized bore with negative taper less elasticity is available due to less interference remaining after it passes through the smaller entry diameter.

While the above embodiment includes a ZI region having positive taper, where a diameter of the bore along the length of the ZI region, as measured in a direction perpendicular to the longitudinal axis 24, decreases a constant rate (i.e., the bore surface has a fixed taper angle θ between surface 30b and longitudinal axis 24) in the direction of insertion of the edge filter, the positive taper can include a bore in the ZI region of any shape that decreases in diameter in the edge filter insertion direction (or the direction of fuel flow). For example, the positive taper in the ZI region can have a curved profile that reduces in diameter (e.g., monotonically, smoothly, piecewise, at an increasing or decreasing rate of change etc.) in the direction of insertion would provide for increased retention force along the ZI region of the installed edge filter.

FIG. 5 is a diagram of an profile of an exemplary bore 20c for retaining an edge filter (not shown in FIG. 5), where a surface 30c of the bore 20c forms a curved positive taper in the ZI region, such that a diameter of the bore 20c in the ZI region, as measured in a direction perpendicular to the longitudinal axis 24, decreases smoothly and at a non-constant rate along the length of the ZI region in the direction of insertion of the edge filter (or in the fuel flow direction).

FIG. 6 is a diagram of an exemplary bore 20d for retaining an edge filter (not shown in FIG. 6). The bore 20d can be used in any edge filter assembly described herein. The bore 20d in the ZI region includes plural adjacent surfaces 30d₁ and 30d₂, each having a respective positive taper angle θ₁ and θ₂. The taper angle thus changes in piecewise manner and θ₁ is less than θ₂ to maintain a decreasing diameter along the length of the ZI region in the direction of insertion of the edge filter. That is, the bore surface in the ZI region includes plural adjacent frusto-conical sections along the bore axis 24 where the frusto-conical surface 30d₂ has a larger cone angle than frusto-conical surface 30d₁, and a diameter of each of the surfaces 30d₁, 30d₂, as measured in a direction perpendicular to the longitudinal axis 24, decreases in the direction of insertion of the edge filter (or in the fuel flow direction). While FIG. 6 shows only two surfaces 30d₁, 30d₂ having respective taper angles different from each other, other embodiments can include more than two surfaces, with each successive surface along the insertion direction having a greater taper angle relative to the longitudinal axis 24 than the previous surface.

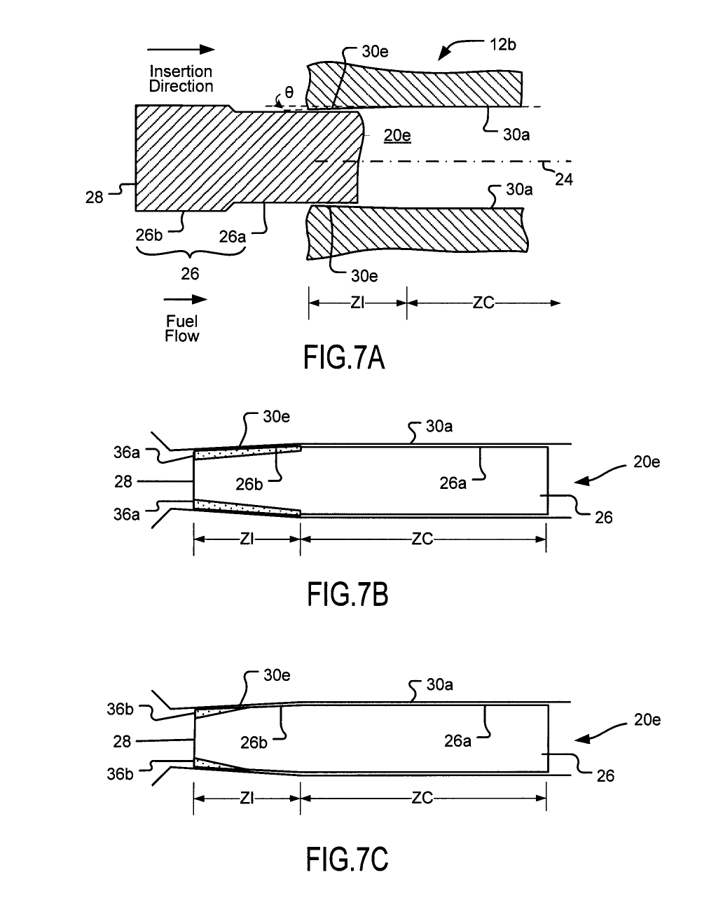

FIGS. 7A to 7C show a comparative example where the shape of the interference zone is not properly controlled, where the resultant interference zone has a tapered part having low or no interference under high pressure. In this instance, a negative taper resulted from a manufacturing process for a typical interference fit because there is a diameter tolerance, and within that tolerance, certain restrictive control of the bore is not specified.

As shown in FIG. 7A, an HPC 12b of, where a bore 20e has an annular surface 30e including a negative taper in the ZI region. That is, a diameter of annular surface 30e increases in the direction of fuel flow (or edge filter insertion direction) to define a negative taper. The negative taper begins increasing from a diameter smaller than a diameter of the ZC region where filtration takes place and increase in the direction of fuel flow until reaching a diameter equal to a diameter of the ZC region, as shown by the horizontal dashed line extending from the annular surface 30a in the ZC region. In other words, the annular surface 30e in the ZI region forms a negative taper angle θ with a line parallel with the longitudinal axis 24.

FIG. 7B conceptually illustrates elastic recovery potential 36a remaining in the edge filter 26, with the edge filter 26 installed in a bore, having negative taper, and subject to low pressure or in an unpressurized state. With negative taper, the whole length of the edge filter surface 26b corresponding to the ZI region has to pass through the smallest diameter of the HPC 12b during insertion. As the edge filter 26 passes through the smallest diameter of the HPC 12b, the edge filter 26 yields and conforms to the smallest diameter of the HPC 12b along the entire length of interference. After the edge filter 26 passes through the smallest diameter (i.e., a “neck region”) at the fuel flow receiving end of the HPC 12b, the edge filter 26 has to expand to maintain contact with the diverging HPC bore 20e. This expansion comes from the finite amount of elasticity recovery due to interference of edge filter 26 and HPC 12b. However, the elastic recovery potential 36a associated with the negative taper decreases in the direction fuel flow starting from the end 28 of the edge filter 26 because of unrecoverable plastic deformation of the edge filter after passing through the neck region. In other words, the recovery potential decreases along the length of the ZI region in the direction of increasing diameter of the annular surface 30e. As a result, an amount of available elastic recovery in the edge filter 26 installed in a bore with a negative taper can be significantly less than an amount of elastic recovery available in an edge filter installed in a bore with a positive taper. Furthermore, the available elastic recovery further diminishes with the bore 20e under high fuel pressure or in a pressurized state to further reduce available contact pressure, as shown by the diminishing available elastic potential 36b in FIG. 7C.

Embodiments of consistent with the present disclosure provide an edge filter assembly having a bore with a geometric feature that can reliably retain an edge filter in its position when the bore is dilated under high pressure. Further, embodiments according to the present disclosure provide a robust press fit of an edge filter without costly hardening and heat treatment processing of edge filter material.

Although a limited number of embodiments is described herein, one of ordinary skill in the an will readily recognize that there could be variations to any of these embodiments and those variations would he within the scope of the disclosure.

What is claimed is:

1. An edge filter assembly for supplying filtered fuel to a cylinder of an internal combustion engine, comprising:
a body including a passage for flowing pressurized fuel, said passage including a longitudinal axis, a fuel inlet, a fuel outlet positioned downstream of the fuel inlet in a direction of fuel flow, and a bore including a first annular surface and a second annular surface adjacent to, and downstream of, the first annular surface in the direction of fuel flow; and
an edge filter positioned in the bore, said edge filter including a first surface in interference fit with the first annular surface, and a second surface circumferentially surrounded by, and spaced from, the second annular surface;
wherein said interference fit has a length along the direction of fuel flow and the first annular surface has a positive taper along said length.

2. The edge filter assembly according to claim 1, wherein the diameter of the bore, as measured in a direction perpendicular to the longitudinal axis, decreases along said length in the direction of fuel flow.

3. The edge filter assembly according to claim 2, wherein, along the entirety of said length, the positive taper forms a substantially constant angle with a line parallel to the longitudinal axis.

4. The edge filter assembly according to claim 1, wherein the first annular surface has a frusto-conical shape and the second annular surface has a cylindrical shape.

5. The edge filter assembly according to claim 1, wherein said length is 10% to 30% of the entire length of the edge filter, as measured along the longitudinal axis.

6. The edge filter assembly according to claim 1, wherein the body includes a conical surface at the fuel inlet configured to sealingly engage with a complementary surface of a high pressure fuel line.

7. The edge filter assembly according to claim 1, wherein the positive taper is curved along said length.

8. A high pressure connector and edge filter assembly for providing a pressurized fluid connection between a high pressure fuel line and an inlet of a fuel injector, comprising:
a fuel inlet end and a fuel outlet end, said fuel inlet and outlet ends configured to mechanically and sealingly engage with the high pressure fuel line and the inlet of the fuel injector, respectively; and
an inner passage extending between the fuel inlet end and the fuel outlet end and containing an edge filter, said inner passage including a frusto-conically shaped surface forming an interference fit with a first surface portion of the edge filter, and a cylindrically shaped surface extending from said conical surface towards the fuel outlet end and radially spaced from a rib surface portion of the edge filter.

9. The high pressure connector and edge filter assembly according to claim 8, wherein a diameter of the conically shaped surface decreases along said interference fit in a direction from the fuel inlet end to the fuel outlet end.

10. The high pressure connector and edge filter assembly according to claim 9, wherein the diameter of the conically shaped surface decreases to a minimum diameter at an interface of the conically shaped surface and the cylindrically shaped surface.

11. The high pressure connector and edge filter assembly according to claim 10, wherein the minimum diameter is the same diameter as substantially the entire cylindrically shaped surface.

12. The high pressure connector and edge filter assembly according to claim 8, wherein the taper of the conically shaped surface forming the interference fit with a first surface portion of the edge filter includes a positive taper such that the diameter of the conically shaped surface decreases in the direction from the fuel inlet end to the fuel outlet end.

13. The high pressure connector and edge filter assembly according to claim 8, wherein the length of the interference fit is 10% to 30% of the entire longitudinal length of the edge filter.
